(19) United States
(12) Patent Application Publication
(10) Pub. No.: US 2013/0036171 A1
(43) Pub. Date: Feb. 7, 2013

(54) SOCIAL MEDIA CONTENT AGGREGATION AND SEARCH MECHANISM

(71) Applicant: Tindley Whipple Gilbert, Lincolnshire, IL (US)

(72) Inventor: Tindley Whipple Gilbert, Lincolnshire, IL (US)

(73) Assignee: FLASHBACK, INC., Lincolnshire, IL (US)

(21) Appl. No.: 13/566,076

(22) Filed: Aug. 3, 2012

Related U.S. Application Data
(60) Provisional application No. 61/515,240, filed on Aug. 4, 2011.

(51) Int. Cl. G06F 15/16

(52) U.S. Cl. 709/204

(57) ABSTRACT

A machine-implemented method can include importing social media content from multiple social media sites, applying filters to the imported content, creating a virtual shoebox based on the filtered content, and generating a virtual scrapbook based on the virtual shoebox. A system can include a social media content import mechanism, a filter mechanism, a virtual shoebox creation mechanism, and a virtual scrapbook generation mechanism.

### CROSS-REFERENCE TO RELATED APPLICATION

The present application claims the benefit of U.S. Provisional Patent Application Ser. No. 61/515,240 which is titled “INTELLIGENT QUERYING AND AGGREGATION OF SOCIAL MEDIA CONTENT” and was filed on Aug. 4, 2011, the content of which is hereby incorporated by reference herein in its entirety.

### TECHNICAL FIELD

The disclosed technology pertains generally to social media content management, and more particularly to tools and techniques for creating and managing content-based products including, but not limited to, virtual scrapbooks.

### BACKGROUND

The popularity of social media sites, such as Facebook, has skyrocketed over the past several years. Such sites generally enable users to post pictures, write status updates or comments, post any of a number of different files, and establish a wide variety of connections or links therebetween. While the amount of content and information accessible by a user is typically vast and rich, the user is presented with very few, if any, options for producing quality items based on such content. Search mechanisms are usually restrained and there are various limitations on the user's ability to selectively filter the content.

Thus, there remains a need for a way to address these and other problems associated with the prior art.

### SUMMARY

Embodiments of the disclosed technology generally pertain to systems and methods configured to allow a user to import social media content from one or more social media sites, apply one or more filters to the imported content, create one or more virtual shoeboxes based on the filtered content, and generate one or more virtual scrapbooks that are each based on at least one virtual shoebox. Soft copies and/or hard copies of one or more virtual scrapbooks may be produced and shared with others, for example.

### BRIEF DESCRIPTION OF THE DRAWINGS

FIG. 1 illustrates an example of a machine-implemented method in accordance with certain embodiments of the disclosed technology.

FIG. 2 illustrates an example of a social media content management home page in accordance with certain embodiments of the disclosed technology.

FIG. 3 illustrates an example of a social media content and friend import page in accordance with certain embodiments of the disclosed technology.

FIG. 4 illustrates an example of a friend management page in accordance with certain embodiments of the disclosed technology.

FIG. 5 illustrates a more detailed example of one of the entries, specifically the first entry, in the listing of friends presented by the friend management page illustrated by FIG. 4 in accordance with certain embodiments of the disclosed technology.

FIG. 6 illustrates an example of a social media content search tool page in accordance with certain embodiments of the disclosed technology.

FIG. 7 illustrates an example of a virtual shoebox management page in accordance with certain embodiments of the disclosed technology.

FIG. 8 illustrates an example of a virtual scrapbook management page in accordance with certain embodiments of the disclosed technology.

FIG. 9 illustrates an example of a networked system in which certain embodiments of the disclosed technology may be implemented.

### DETAILED DESCRIPTION

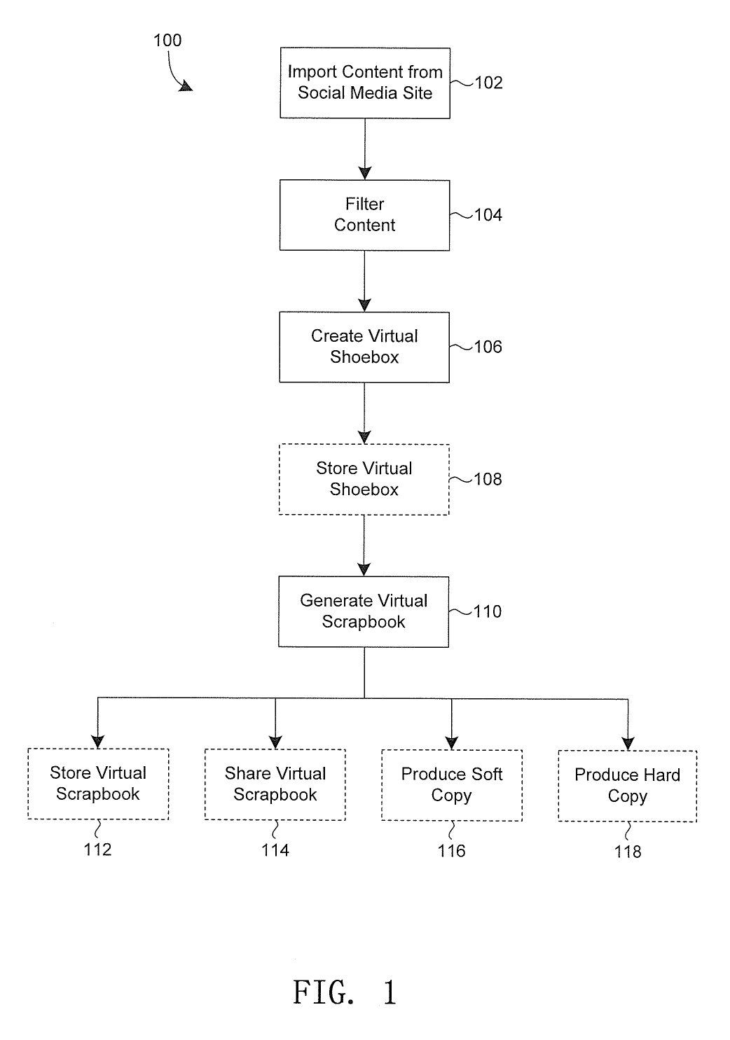

FIG. 1 illustrates an example of a machine-implemented method 100 in accordance with certain embodiments of the disclosed technology. At 102, content is imported from one or more social media sites. As used herein, the term ‘social media site’ generally refers to any website on which one or more users may post social media content, such as Facebook, Myspace, LinkedIn, Shutterfly, Twitter, Pinterest, and Instagram, for example. As used herein, the term ‘social media content’ or ‘content’ generally refers to images, videos, comments or other text, date information, identification data, links, user profiles, or other data or information that may be posted or otherwise accessible on or from the social media site(s). A user may direct such content to be imported by way of a social media content import mechanism, such as the social media content and friend import page 300 illustrated by FIG. 3, which is described in detail below.

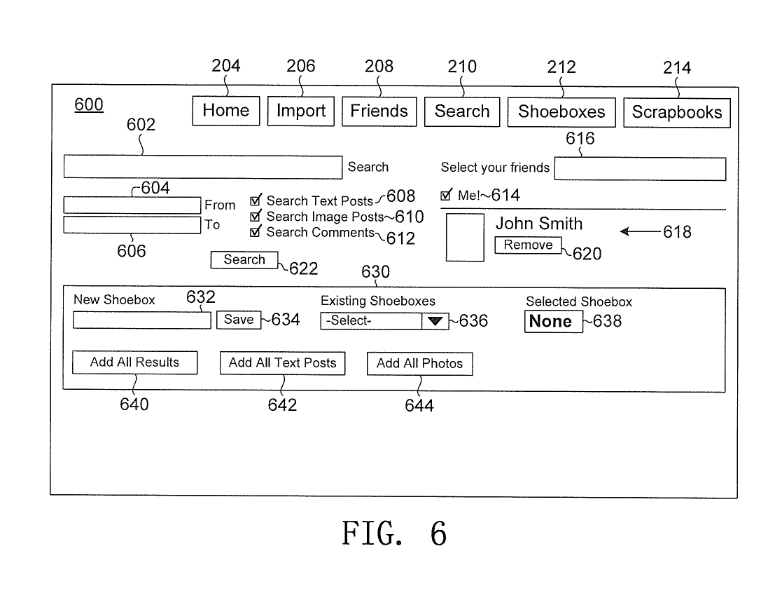

At 104, the social media content may be filtered. For example, the user may apply one or more filters to the content. Alternatively or in addition thereto, one or more filters may be automatically applied to the content. The user may create his or her own filters, use previously created filters, edit previously created filters, or any combination thereof Examples of such filter mechanisms are described in detail below with reference to the social media content search tool page 600 illustrated by FIG. 6.

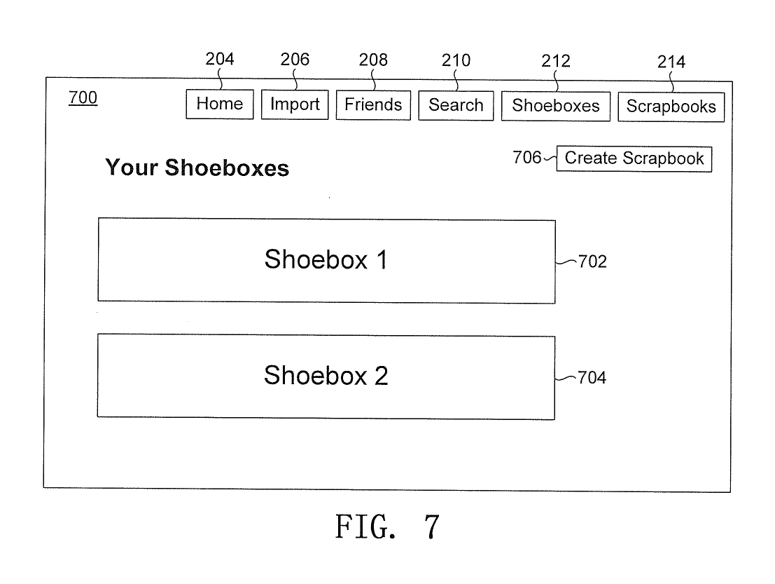

At 106, a virtual shoebox is created. As used herein, the term ‘virtual shoebox’ generally refers to a file, collection of files, folders, or any combination thereof that includes at least a portion of the filtered content, links or references to at least a portion of the filtered content, or a combination thereof. Examples of virtual shoeboxes are described in detail below with reference to the virtual shoebox management page 700 illustrated by FIG. 7. The virtual shoebox created at 106 may be optionally stored, as indicated by 108.

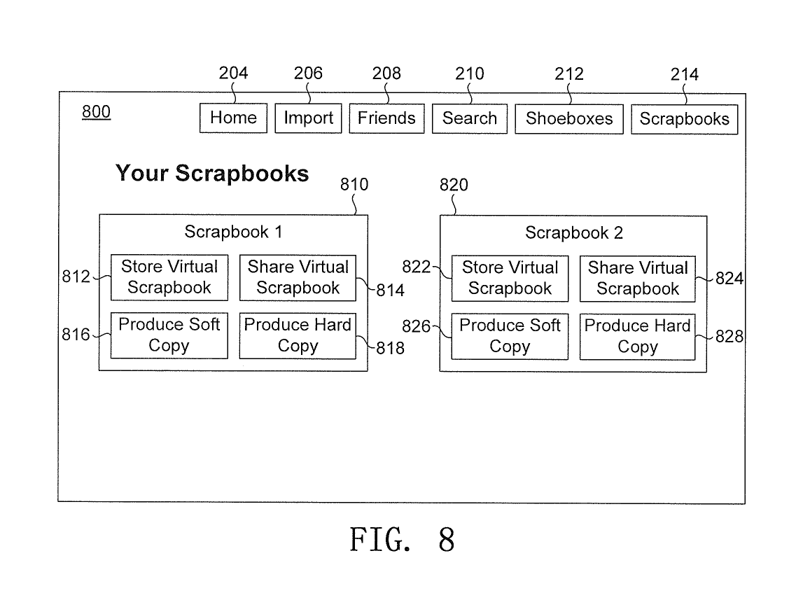

At 110, a virtual scrapbook is created. As used herein, the term ‘virtual scrapbook’ generally refers to a visual and/or audible representation of a corresponding virtual shoebox. A virtual scrapbook can include one or more individual files, folders, or collection thereof. For example, a virtual scrapbook may include a portable document format (PDF) file that, when accessed by the user, provides the user with a visual and/or audible representation of the corresponding virtual shoebox. Examples of virtual scrapbooks are described in detail below with reference to the virtual scrapbook management page 800 illustrated by FIG. 8.

Once a virtual scrapbook has been generated at 110, the virtual scrapbook may be optionally stored and/or shared, as indicated by 112 and 114, respectively. Alternatively or in addition thereto, a soft copy and/or hard copy of the virtual scrapbook may be produced, as indicated by 116 and 118, respectively. For example, the user may cause a copy of the virtual scrapbook to be stored on a flash drive or other portable storage device and also send a copy of the virtual scrapbook to a user or site to be published as a print document, album, book, or other suitable viewing and/or listening medium. The user may also share a virtual scrapbook by way of an electronic communication, such as an email message or tweet, across one or more social networking sites. The virtual scrapbook, e.g., by way of an electronic communication, may be further shared, stored, and/or used to produce physical media by others.

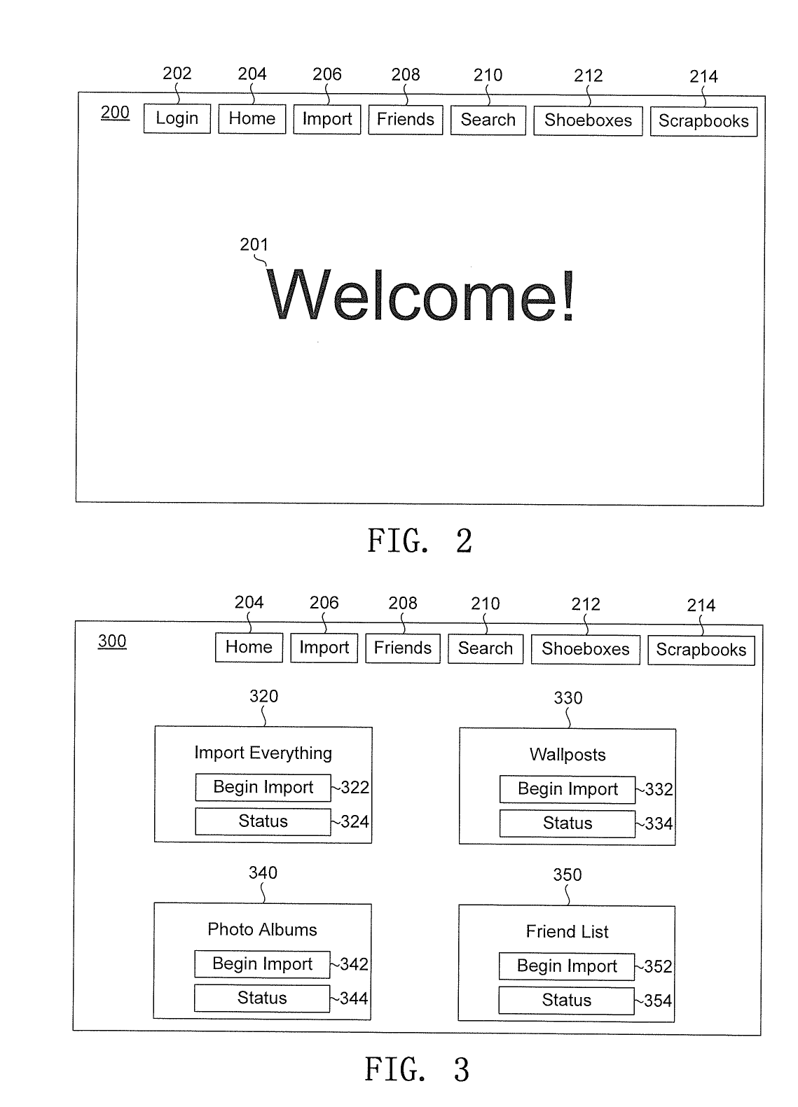

FIG. 2 illustrates an example of a social media content management home page 200 in accordance with certain embodiments of the disclosed technology. In the example, the home page 200 provides a welcome message 201 or image and includes a Login button 202 and a number of menu buttons 204-214 that each cause certain functionality to be invoked responsive to the user selecting the corresponding button.

Responsive to the user selecting the Login button 202, the user may be prompted for login credentials and/or other login information. For example, the user may be asked to provide login credentials, e.g., a username and password, for a social media site account such as his or her Facebook account. In certain embodiments, the other menu buttons 204-214 may be disabled unless the user provides login credentials that are verified or otherwise validated.

While the Home button 204 is usually disabled on the home page 200, the user may return to the home page 200 when interacting with a different page, e.g., any of the pages illustrated by FIGS. 3, 4, and 6-8, by selecting the home button 200.

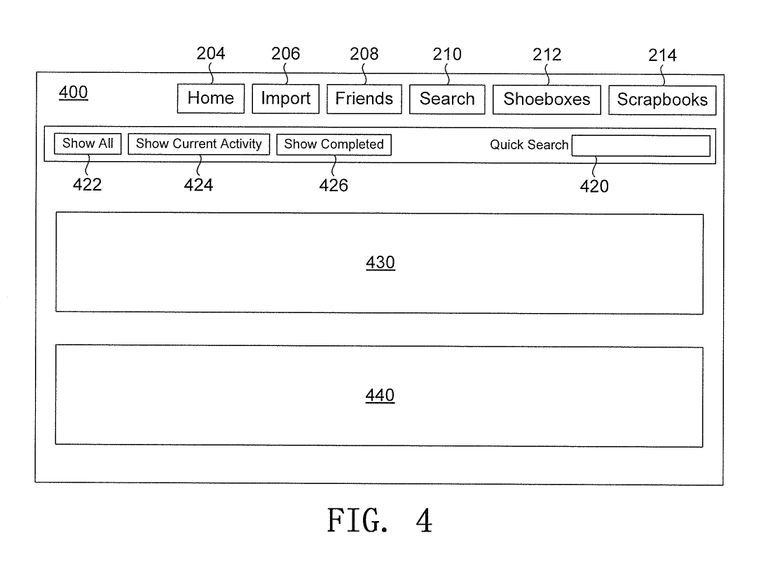

Selection of the Import button 206 may cause the social media content and friend import page 300 illustrated by FIG. 3 to be presented to the user, unless the import page 300 is already being presented to the user. Selection of the Friends button 208 may cause the friend management page 400 illustrated by FIG. 4 to be presented to the user, unless the friend management page 400 is already being presented to the user.

Selection of the Search button 210 may cause the social media content search tool page 600 illustrated by FIG. 6 to be presented to the user, unless the search tool page 600 is already being presented to the user.

Selection of the Shoeboxes button 212 may cause the virtual shoebox management page 700 illustrated by FIG. 7 to be presented to the user, unless the page 700 is already being presented to the user. Selection of the Scrapbooks button 214 may cause the virtual scrapbook management page 800 illustrated by FIG. 8 to be presented to the user, unless the page 800 is already being presented to the user.

While the Login button 202 and menu buttons 204-214 in the example are implemented as standard graphical user interface (GUI) buttons that may be selected by the user, e.g., by way of a mouse or other input device or component, one having ordinary skill in the art will recognize that the functionality corresponding to each of the buttons 202-214 may be invoked in any of a number of different ways using standard or otherwise compatible user input tools and techniques.

Further, while the menu buttons 204-214 as described herein are functionally static, e.g., present at each of the pages illustrated by FIGS. 3, 4, and 6-8, other embodiments may involve the disabling or removal of one or more of the menu buttons 204-214 on certain pages. For example, in situations where the social media content import page 300 illustrated by FIG. 3 is being presented to the user, the Import button 206 may be disabled or removed from the import page 300.

FIG. 3 illustrates an example of a social media content and friend import page 300 in accordance with certain embodiments of the disclosed technology. In the example, the import page 300 includes four import interfaces 320, 330, 340, and 350 that each provides the user with the ability to import social media content based on one or more criteria. Other implementations may include other types of import interfaces. For example, an Import Tweets interface may allow a user to import all of the tweets for his or her personal Twitter account and/or other Twitter accounts. An Import Groups interface may allow a user to import information pertaining to one or more groups that he or she has created at a social media site and/or groups defined by others, e.g., friends.

Selection of the Begin Import button 322 of the Import Everything interface 320 by the user may cause the system to import all of the social media content for the corresponding account, e.g., the user's social media site account, using a connection established based on login credentials provided by the user, e.g., using the Login button 202 on the home page 200.

Selection of the Begin Import button 332 of the Wallposts import interface 330 by the user may cause the system to import all of the data and information pertaining to the wall postings for the corresponding social media site account. For example, if the pertinent social media site account is the user's Facebook account, selection of the Begin Import button 332 by the user may result in the importing of all of the postings and corresponding information on the user's Facebook wall.

Selection of the Begin Import button 342 of the Photo Albums import interface 340 by the user may cause the system to import all of the images and/or videos for the corresponding social media site account. For example, if the pertinent social media site account is the user's Facebook account, selection of the Begin Import button 342 by the user may result in the importing of all of the images and/or video that the user has posted on his or her Facebook account. Alternatively or in addition thereto, links and/or other information in connection with the images and/or videos may be imported. In certain embodiments, images and/or videos in which the user has been tagged (or links thereto) may be imported.

Selection of the Begin Import button 352 of the Friend List import interface 350 by the user may cause the system to import a listing of the friends for the corresponding social media site account, e.g., the user's Facebook account. In certain embodiments, information corresponding to the friends, e.g., phone numbers, mailing addresses, email addresses, wall postings, statuses, links, and posted images and videos, may also be imported.

As with the Login button 202 and menu buttons 204-214 of FIG. 2, the various buttons used in connection with the import page 300 in the present example are implemented as standard GUI buttons. However, one having ordinary skill in the art will recognize that the functionality associated with any or all of these buttons may be implemented using any of a number of different ways using standard or otherwise compatible user input tools and techniques.

Status indicators 324, 334, 344, and 354 of the import interfaces 320, 330, 340, and 350, respectively, may provide a visual indication as to a real-time status of the corresponding import activity. Also, any or all of the social media content imported as a result of the user selecting any of the Begin Import buttons 322, 332, 342, and 352 may be stored locally, by a remote storage device, or both.

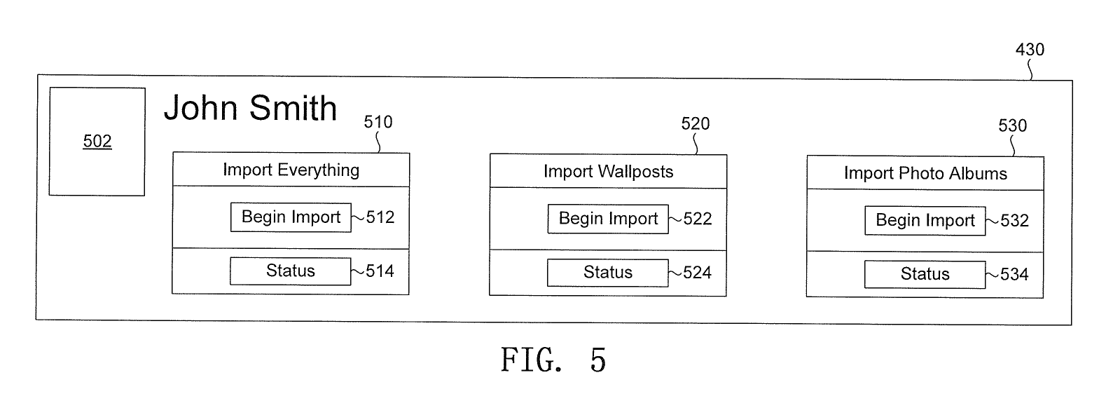

FIG. 4 illustrates an example of a friend management page 400 in accordance with certain embodiments of the disclosed technology. In the example, the friend management page 400 is currently presenting a listing of two entries 430 and 440 that each corresponds to a particular friend. A detailed description of one of the entries in the listing, specifically the first entry 430, is provided below with regard to FIG. 5.

The friend management page 400 includes a Show All button 422 that, when selected by the user, may present a visual listing of all of the friends that have been imported, e.g., using the social media content and friend import page 300 illustrated by FIG. 3. The visual listing may include any of a number of identifiers for each friend included in the listing, such as a thumbnail photo, e.g., from the friend's Facebook account, a handle, e.g., from the friend's Twitter account, or any combination thereof.

Selection of a Show Current Activity button 424 by the user may cause the visual listing to be limited to only friends with current activity happening on the site, e.g., friends whose information the user is currently downloading. Selection of a Show Completed button 426 by the user may cause the visual listing to be limited to only friends with no further download activity, e.g., friends who were selected by the user and whose content has been fully downloaded.

A Quick Search field 420 may allow the user to type, or begin typing, the name or other identifying information for a friend therein. Responsive thereto, the field 420 may present a visual listing of friends corresponding to the information provided therein. The user may thus use the Quick Search field 420 to find and select a friend quickly.

As with other buttons described above, the buttons 422, 424, and 426 used in connection with the friend management page 400 in the present example are implemented as standard GUI buttons. However, one having ordinary skill in the art will recognize that the functionality associated with any or all of these buttons may be implemented using any of a number of different ways using standard or otherwise compatible user input tools and techniques.

FIG. 5 illustrates a more detailed example of one of the entries, specifically the first entry 430, in the listing of friends presented by the friend management page 400 illustrated by FIG. 4 in accordance with certain embodiments of the disclosed technology. In the example, the entry 430 includes an identifier 502, such as a photo of the friend, social media site username, handle, or some combination thereof.

The friend management page also includes three import interfaces 510, 520, and 530 that each provides the user with the ability to import social media content corresponding to the friend based on one or more criteria. Other implementations may include other types of import interfaces, such as an Import Tweets interface or an Import Groups interface, for example, in place of or in addition to the import interfaces 510, 520, and 530 in the example.

Selection of the Begin Import button 512 of the Import Everything interface 510 by the user may cause the system to import all of the social media content for the corresponding account, e.g., the friend's social media site account. In certain embodiments, the social media content to be imported may be limited by permissions granted to the user by the friend.

Selection of the Begin Import button 522 of the Wallposts import interface 520 by the user may cause the system to import all of the data and information pertaining to the wall postings for the corresponding social media site account. For example, if the pertinent social media site account is the friends Facebook account, selection of the Begin Import button 522 by the user may result in the importing of all of the postings and corresponding information on the friend's Facebook wall that are accessible by the user.

Selection of the Begin Import button 532 of the Photo Albums import interface 530 by the user may cause the system to import all of the images and/or videos for the corresponding social media site account. For example, if the pertinent social media site account is the friend's Facebook account, selection of the Begin Import button 532 by the user may result in the importing of all of the images and/or video that the friend has posted on his or her Facebook account that are accessible by the user, and/or links thereto. In certain embodiments, images and/or videos, wall posts, etc. in which the friend has been tagged (or links thereto) may be imported.

Status indicators 514, 524, and 534 of the import interfaces 510, 520, and 530, respectively, may provide a visual indication as to a real-time status of the corresponding import activity. Also, as with the social media content imported as a result of the user selecting any of the Begin Import buttons 322, 332, 342, and 352 of the social media content and friend import page 300 illustrated by FIG. 3, any or all of the social media content imported as a result of the user selecting any of the Begin Import buttons 512, 522, and 532, once searched and collected within one or more virtual shoeboxes, may be stored locally, by a remote storage device, or both.

FIG. 6 illustrates an example of a social media content search tool page 600 in accordance with certain embodiments of the disclosed technology. In the example, a user may enter one or more search terms in a search field 602. The user may specify a certain date range using date fields 604 and 606. Alternatively or in addition thereto, the user may specify whether the search is to be applied to text posts, image posts, and/or comments by way of check boxes 608, 610, and 612, respectively. Other implementations may provide the user with further search specifications, such as one or more pertinent social media sites, types of content, e.g., tweets, or a “search all” option to perform the search across all of the social media content that has been imported by the user.

The user may specify whether the search is to be conducted against the user's own imported social media content by way of a checkbox 614. Alternatively or in addition thereto, the user may specify whether the search is to be conducted against the imported social media content corresponding to one or more friends by way of a field 616 in which the user may type, or begin to type, the desired friend's name or other identifying information and selecting the friend. Selection of the friend(s) may be visually confirmed by way of a listing 618 of the friend(s). A Remove button 620 may be used by the user to remove one or more of the friend(s) in the listing 618.

Once the user has indicated all of the desired parameters for the search, he or she may cause the search to be performed by selecting a Search button 622. As used herein, the performing of a search effectively constitutes an application of a filter to the social media content.

In the example, the search tool page 600 also includes a virtual shoebox panel 630 configured to allow a user to save the results of the search as a virtual shoebox by entering the desired name of the virtual shoebox into field 632 and selecting the Save button 634. In alternative embodiments, or after the user has saved the current virtual shoebox, the user may select a previously saved virtual shoebox by way of a selection mechanism 636. An indicator 638 may provide a visual indication as to which virtual shoeboxes, if any, have been selected by the user.

Once the user has selected one or more virtual shoeboxes, he or she may add some or all of the search results to the selected virtual shoebox(es). For example, the user may select an Add All Results button 640 to cause the system to add all of the search results to the selected shoebox(es). Alternatively, the user may select an Add All Text Posts button 642 or an Add All Photos button 644 to cause the system to all only text posts or images, respectively, to the selected shoebox(es). Other implementations may include other types of buttons. For example, an Add All Tweets button may allow a user to add all of the imported tweets to the selected shoebox(es).

As with other input mechanisms described above, the various input mechanisms, e.g., buttons, checkboxes, and fields, used in connection with the search tool page 600 in the present example are implemented as standard GUI input mechanisms. However, one having ordinary skill in the art will recognize that the functionality associated with any or all of these buttons may be implemented using any of a number of different ways using standard or otherwise compatible user input tools and techniques. The same is true of other user input mechanisms described herein, such as those described below with regard to the virtual shoebox management page 700 illustrated by FIG. 7 and the virtual scrapbook management page 800 illustrated by FIG. 8.

FIG. 7 illustrates an example of a virtual shoebox management page 700 in accordance with certain embodiments of the disclosed technology. In the example, the virtual shoebox management page 700 is currently presenting a listing of two entries 702 and 704 that each correspond to a virtual shoebox. The entries 702 and 704 may each include an identifier and, in certain embodiments, other information pertaining to the corresponding virtual shoebox. For example, the entries 702 and 704 in the listing may each provide a visual indication of certain characteristics of the corresponding virtual shoebox, such as the types and size of the social media content associated with the shoebox. Selection of a Create Scrapbook button 706 by the user may cause the system to generate a virtual scrapbook corresponding to the virtual shoebox.

FIG. 8 illustrates an example of a virtual scrapbook management page 800 in accordance with certain embodiments of the disclosed technology. In the example, the virtual scrapbook management page 800 is currently presenting a listing of two virtual scrapbook summary panels 810 and 820 that each correspond to a virtual scrapbook. Selection of a Store Virtual Scrapbook button 812 or 822 by the user may cause the system to cause the corresponding virtual scrapbook to be stored, e.g., locally or remotely. Selection of a Share Virtual Scrapbook button 814 or 824 by the user may cause the system to allow the user to share the corresponding virtual scrapbook with at least one other user or entity, e.g., by an email message from the user or by way of a shared website or other online location. In certain embodiments, other users, e.g., friends, may view, share, and/or save any or all of the user's virtual scrapbooks.

Selection of a Produce Soft Copy button 816 or 826 by the user may cause the system to generate a soft copy, e.g., a PDF document, of the corresponding virtual scrapbook. Selection of a Produce Hard Copy button 818 or 828 by the user may cause the system to cause a hard copy of the corresponding virtual scrapbook to be created. For example, the system may place an order with an online publisher or other entity to produce a physical document, album, etc. based on the virtual scrapbook.

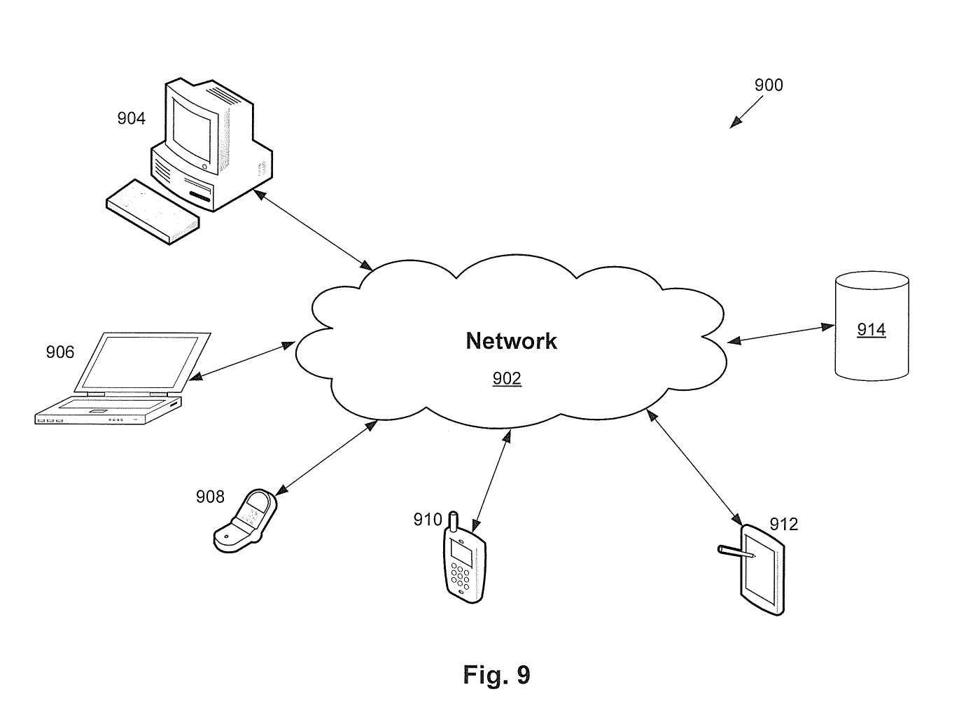

FIG. 9 illustrates an example of a networked system 900 in which certain embodiments of the disclosed technology may be implemented. In the example, the system 900 includes a network 902, such as the Internet, an intranet, a home network, or combination thereof. Personal computers 904 and 906 may connect to the network 902 to communicate with each other or with other devices connected to the network. The system 900 also includes three mobile electronic devices 908, 910, and 912. In the example, two of the mobile electronic devices 908 and 910 are communications devices such as cellular telephones or smart phones such as an Apple iPhone. A storage device 914 may store some of all of the data and information, including but not limited to social media content, virtual shoeboxes, and virtual scrapbooks, that may be accessed and used by any of the computers 904 and 906 or mobile electronic devices 908-912.

The following discussion is intended to provide a brief, general description of a suitable machine in which embodiments of the disclosed technology can be implemented. As used herein, the term “machine” is intended to broadly encompass a single machine or a system of communicatively coupled machines or devices operating together. Exemplary machines may include computing devices such as personal computers, workstations, servers, portable computers, handheld devices, tablet devices, and the like.

Typically, a machine includes a system bus to which processors, memory such as random access memory (RAM), read-only memory (ROM), and other state-preserving medium, storage devices, a video interface, and input/output interface ports can be attached. The machine may also include embedded controllers such as programmable or non-programmable logic devices or arrays, Application Specific Integrated Circuits (ASICs), embedded computers, smart cards, and the like. The machine may be controlled, at least in part, by input from conventional input devices such as keyboards and mice, as well as by directives received from another machine, interaction with a virtual reality (VR) environment, biometric feedback, or other pertinent input.

The machine may utilize one or more connections to one or more remote machines, such as through a network interface, modem, or other communicative coupling. Machines can be interconnected by way of a physical and/or logical network, such as an intranet, the Internet, local area networks, wide area networks, etc. One having ordinary skill in the art will appreciate that network communication may utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

Embodiments of the disclosed technology may be described by reference to or in conjunction with associated data including functions, procedures, data structures, application programs, instructions, etc. that, when accessed by a machine, may result in the machine performing tasks or defining abstract data types or low-level hardware contexts. Associated data may be stored in, for example, volatile and/or non-volatile memory, such as RAM and ROM, or in other storage devices and their associated storage media, which can include hard-drives, floppy-disks, optical storage, tapes, flash memory, memory sticks, digital video disks, biological storage, and other non-transitory, physical storage media.

Associated data may be delivered over transmission environments, including the physical and/or logical network, in the form of packets, serial data, parallel data, etc., and may be used in a compressed or encrypted format. Associated data may be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

We claim:

1. A machine-implemented method, comprising:
importing social media content from one or more social media sites;
applying at least one filter to the imported social media content;
creating a virtual shoebox based on the filtered social media content; and
generating a virtual scrapbook based on the virtual shoebox.

2. The machine-implemented method of claim 1, further comprising storing the virtual shoebox.

3. The machine-implemented method of claim 1, further comprising storing the virtual scrapbook.

4. The machine-implemented method of claim 1, further comprising sharing the virtual scrapbook.

5. The machine-implemented method of claim 1, further comprising producing a soft copy of the virtual scrapbook.

6. The machine-implemented method of claim 1, further comprising producing a hard copy of the virtual scrapbook.

7. The machine-implemented method of claim 6, wherein the hard copy comprises at least one of a group consisting of: a document, an album, and a book.

8. The machine-implemented method of claim 1, wherein the virtual scrapbook comprises a portable document format (PDF) file.

9. The machine-implemented method of claim 1, wherein applying at least one filter comprises specifying at least one search term.

10. The machine-implemented method of claim 1, wherein applying at least one filter comprises specifying a date range corresponding to the imported social media content.

11. The machine-implemented method of claim 1, wherein applying at least one filter comprises specifying imported social media content corresponding to the user.

12. The machine-implemented method of claim 1, further comprising selecting at least one friend.

13. The machine-implemented method of claim 12, wherein importing social media content from the social media site comprises importing social media content corresponding to an account of the at least one friend at the social media site.

14. The machine-implemented method of claim 13, wherein applying at least one filter comprises specifying imported social media content corresponding to the at least one friend.

15. The machine-implemented method of claim 13, wherein the social media content comprises at least one of a group consisting of: text, images, and videos posted by the friend.

16. The machine-implemented method of claim 13, wherein the social media content comprises at least one of a group consisting of: text, images, and videos in which the friend has been tagged.

17. The machine-implemented method of claim 1, wherein the social media content comprises at least one of a group consisting of: text, images, videos, and additional content posted by the user.

18. The machine-implemented method of claim 1, wherein the social media content comprises at least one of a group consisting of: text, images, and videos in which the user has been tagged or mentioned.

19. One or more tangible, non-transitory computer-readable media storing executable instructions that, when executed by a processor, cause the processor to perform the machine-implemented method of claim 1.

20. A system, comprising:
a social media content import mechanism configured to import social media content from social media sites;
a filter mechanism configured to apply at least one filter to the imported social media content;
a virtual shoebox creation mechanism configured to create a virtual shoebox based on the filtered social media content; and
a virtual scrapbook generation mechanism configured to generate a virtual scrapbook based on the virtual shoebox.
